(19) United States
(12) Patent Application Publication
(10) Pub. No.: US 2006/0089438 A1
(43) Pub. Date: Apr. 27, 2006

(54) Method for applying artificial desert varnish to exposed rock surfaces

(76) Inventors: Rick Lewis Beatty, Hurricane, UT (US); Hans William Rasmussen, Mesquite, NV (US)

Correspondence Address: RICK LEWIS BEATTY, 554 SOUTH 180 WEST, HURRICANE, UT, 84737, US

(21) Appl. No.: 11/228,426

(22) Filed: Sep. 15, 2005

Related U.S. Application Data
(60) Provisional application No. 60/610,516, filed on Sep. 15, 2004.

(51) Int. Cl. C08K 5/05

(52) U.S. Cl. 524/379

(57) ABSTRACT

A novel method for applying Artificial Desert Varnish to exposed rock surfaces using organic compounds to utilize the polar nature of organic alcohols, organic ethers or other functional groups to chelate with the applied Artificial Desert Varnish providing a bonding or binding mechanism that strengthens the adherence properties and seals the colorants into and onto the rock mineral surfaces enhancing stability and longevity of the Artificial Desert Varnish colors.

### CROSS-REFERENCE TO RELATED APPLICATIONS

This application claims the benefit of provisional patent application Ser. No. 60/610,516, Filed Sep. 15, 2004 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to a method for applying a bonding or binding mechanism that strengthens adherence properties and seals colorants into and onto the rock mineral surfaces enhancing stability and longevity of the colors.

2. Prior Art

There are various compositions and mixtures available that through the use of High Molar concentrations of the metal salts of Iron, Manganese, Chrome and others, will impart a topical stain to disturbed or broken rock surfaces. These unprotected stains are subject to color change by weathering processes, and are usually restricted to darker brown or black colors.

The High Molar concentrations are difficult to apply and usually require multiple coatings of acidic or base pre-treatment to achieve the desired patina. Once this is achieved our invention a method for applying a bonding or binding mechanism that strengthens adherence properties and seals colorants into and onto the rock mineral surfaces enhancing stability and longevity of the colors.

Another Prior Art method using the current state-of-the-art for restoration using the higher concentrations of metallic salts in aqueous solution. The metal salt solutions are used in the Chloride or Acetate form of the metals. The Manganese and Iron salts used to color the surface of rocks to give it the Desert Varnish finish look by using our invention method for applying Artificial Desert Varnish to exposed rock will provide a bonding or binding mechanism that strengthens the adherence properties and seals the colorants into and onto the rock mineral surfaces enhancing stability and longevity of the colors. Prior Art does not seal the colorant.

Another Prior Art method of forming a decorative surface comprises treating the rock surface with a wash medium having one or more thin coatings of clear polyurethane causing the rock surface to have a shiny surface. The Prior Art lacks the ability to simulate the natural desert varnish. However, by not using the clear polyurethane but using our invention method it will provide a bonding or binding mechanism that strengthens the adherence properties and seals the colorants into and onto the rock mineral surfaces enhancing stability and longevity of the colors used to simulate the natural desert varnish. Prior Art does not seal the colorant.

Another Prior Art method of simulating natural desert varnish comprises using Sodium Hydroxide and Potassium Hydroxide, Manganese Chloride and Iron Sulfate and Sodium Hypochloride. Our invention provides a bonding or binding mechanism that strengthens the adherence properties and seals the colorants into and onto the rock mineral surfaces enhancing stability and longevity of the colors. The Prior Art does not seal the colorant.

Another Prior Art method for staining concrete comprising saturated Hydrochloric Acid solutions of blended metallic salts that are chemically reactive with masonry concrete, stone and like materials Our invention provides a bonding or binding mechanism that strengthens the adherence properties and seals the colorants into and onto the rock mineral surfaces Enhancing stability and longevity of the colors. The Prior Art does not seal the colorant.

Another Prior Art method relates to the use of the natural absorption and chelating ability of Humic Acid or Fulvic Acid to chelate transition metal salts of group 6 through 8 transition metal series for permanent staining of any naturally occurring rock minerals, or industrial forms. Our invention provides a bonding or binding mechanism that strengthens the adherence properties and seals the colorants into and onto the rock mineral surfaces enhancing stability and longevity of the colors. The prior art does not seal the colorants.

### OBJECTS AND ADVANTAGES

Accordingly, besides the objects and advantages described above, several objects and advantages of the present invention are:
(a) to provide a method of bonding or binding mechanism that strengthens the adherence properties.
(b) to provide a method of sealing the colorants into and onto the surfaces enhancing stability and longevity of the colors.
(c) to provide a method to cover unsightly stains or carbonate build-up.
(d) to provide a method for sealing natural colors to Basalt, Rhyolite, Quartzite, Limestone, Dolomite, Brick, Cinderblock and Concrete.
(e) to provide a method for sealing Humic Acids and Fulvic Acids, soluble metal salts, precipitated metal hydroxides, organic and inorganic pigments or clays, as natural colorants.

It is the feature of our invention to provide a bonding or binding mechanism that strengthens the adherence properties and seals the colorants into and onto the surfaces enhancing stability and longevity of the colors when applying Artificial Desert Varnish to exposed rock surfaces.

### DESCRIPTION OF INVENTION

The present invention is the use of organic compounds including but not limited to low concentrations of compatible alkyd, acrylic, or organic resin binders such as a resin or compound containing either a polymeric structure organic alcohol or organic ether with the following structure:

ALCOHOLS

R—CH₂—OH
R₂—CH—OH
R₃—C—OH
Ar—CH₂—OH
ArR—CH—OH
ArR₂—C—OH
Ar—OH
   ETHERS
R—O—R
Ar—O—R

Where the R and Ar represent one of the following: Phenyl, aromatic, alkyl, mono-carbon or polymeric carbon chains.

This allows the organic resin or compound to utilize the polar nature of the organic alcohols, organic ethers, or other functional groups to chelate with the applied Artificial Desert Varnish to exposed rock surfaces providing a bonding or binding mechanism that strengthens the adherence properties and seals the colorants into and onto the rock mineral surfaces enhancing stability and longevity of the colors.

### CONCLUSION AND SCOPE OF INVENTION

Accordingly, the reader will see that the “Method for Applying Artificial Desert Varnish to Exposed Rock Surfaces” of this invention will enhance stability and longevity of the colors.

Although the description above contains specifications, these should not be construed as limiting the scope of the invention but merely providing illustrations of some of the presently preferred embodiments of this invention.

I claim as my invention:

1. Method for applying Artificial Desert Varnish to exposed rock surfaces comprises of the use of organic compounds including but not limited to low concentrations of compatible alkyd, acrylic, or organic resin binders such as a resin or compound containing either a polymeric or non-polymeric structure organic alcohol or organic ether with the following structure:
ALCOHOLS
R—CH₂—OH, R₂—CH—OH, R₃—C—OH, Ar—CH₂—OH, ArR—CH—OH, ArR₂—C—OH, Ar—OH
ETHERS
R—O—R, Ar—O—R
Where the R and Ar represents on of the following: Phenyl, aromatic, alkyl, mono-carbon, or polymeric carbon chains.

2. Method for applying Artificial Desert Varnish to Exposed Rock Surfaces according to claim 1 wherein said organic compounds to utilize the polar nature of said organic alcohols, said organic ethers or other functional groups to chelate with the applied Artificial Desert Varnish providing a bonding or binding mechanism that strengthens the adherence properties and seals the colorants into and onto the rock mineral surfaces enhancing stability and longevity of Artificial Desert Varnish colors.
